(19) United States
(12) Patent Application Publication
(10) Pub. No.: US 2014/0284446 A1
(43) Pub. Date: Sep. 25, 2014

(54) Platform for Whole Body Vibrator Unit

(71) Applicant: Robin Peng, Sandy, UT (US)

(72) Inventor: Robin Peng, Sandy, UT (US)

(21) Appl. No.: 14/223,773

(22) Filed: Mar. 24, 2014

Related U.S. Application Data
(60) Provisional application No. 61/804,587, filed on Mar. 22, 2013.

(51) Int. Cl. A61H 1/00

(52) U.S. Cl. CPC A61H 1/005; A61H 2201/0165; A61H 2201/0107
USPC 248/559

(57) ABSTRACT

Disclosed is a platform for a whole body vibrational apparatus. The platform is powered by a centrally located iso-linear drive system incorporating elastomeric bushings that support the cover of the platform and impart the oscillatory motion from the motor to said cover. The use of the bushings reduces noise and cushions the jarring usually associated with oscillatory motion. The cover is curved in a manner to accommodate the iso-linear drive system and present a lower mounting height to aid in mounting and dismounting the platform. A modular column may also be added to control the vibrator platform but is also isolated from the platform at its connection. Additional control modules, such as a ski module, may be added to further enhance the utility of the platform.

### CROSS-REFERENCES TO RELATED APPLICATIONS

This Application claims priority as a non-provisional perfection of prior filed U.S. provisional application No. 61/804,587, filed Mar. 22, 2013, and incorporates the same by reference in its entirety.

### FIELD OF THE INVENTION

The present invention relates to the field of exercise equipment and more particularly relates to a platform for a modular whole body vibrator unit.

### BACKGROUND OF THE INVENTION

Vibration therapy is well recognized in the medical and therapeutic arts. Vibration is most commonly used for massage and exercise. In principle, a vibration of a given frequency is imparted upon a body part, or even the whole body, for therapeutic effect. Some devices are portable massagers that are applied to body parts. Other devices are larger machines in which a person positions themselves in the device for vibration therapy.

One device that is used is a vibration platform, where the user stands on a platform and the platform is then vibrated, thus a vibration is imparted upon the whole body that may be isolated into individual body areas through various techniques and devices. Control for the vibration platform is usually located on top of the apparatus, in front of the user and hand grips are usually provided so the user may self-stabilize during treatment.

However, the vibration platform is usually a rather thick construction that often also houses the motor and vibration mechanism. As a thicker construction, it can be difficult for some patients to mount and dismount the platform, in particular the elderly or those suffering from injury. A larger platform is also more difficult to move or transport. There is also an issue with noise as the motor and drive train of most prior art whole body vibrators are larger machines with many moving parts.

The present invention is a redesigned whole body vibrator platform featuring an iso-linear drive and a plurality of bushing mounts. The iso-linear drive is centrally located on the platform base and the platform itself is bent in a manner to accommodate the components of the iso-linear drive while presenting a lower platform for easier access to the machine. The utilization of bushing mounts makes the drive system quieter than prior art systems and allow for the use of fewer parts. The bushings also cushion the oscillatory motion, making it less jarring. The platform assembly of the present invention then is one of the quietest and most comfortable drive systems presenting a light unit with a lower profile.

The present invention represents a departure from the prior art in that the platform of the present invention allows for a quiet drive for a whole body vibrator platform while also providing for the lowest possible height and most compact and lightest design to date.

### SUMMARY OF THE INVENTION

In view of the foregoing disadvantages inherent in the known types of vibration platforms, this invention provides a vibration platform with an iso-linear drive. As such, the present invention's general purpose is to provide a new and improved vibration platform that is quiet, gentler on the body, and lower to the ground than previous platforms.

To accomplish these objectives, the vibration platform comprises a motor unit and two support bushings arranged on a base in a single line at the center of what would be the platform. The platform then rests as a carapace over the motor and bushings, being supported by a central strut while the platform sides flare downward and outward from the central strut. The bushings provide the oscillatory force to the platform, providing the quiet and softer vibration.

The platform according to the present invention, then, has numerous advantages over the prior art. It runs softer and quieter than prior art systems. It also tends to be more stable and lighter, thereby being more portable. The light weight allows for a wider and more stable frame. It is also customizable for individual weights and requires less power from the drive system to run.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of the platform.

FIG. 2 is a partially transparent view of the platform of FIG. 1

FIG. 3 is a perspective view of the platform of FIG. 3, attached to a central control column.

FIG. 4 is a sectional view of the foot and attachment point of the platform of FIG. 3, taken along line A-A.

FIG. 5 is a perspective view of the platform of FIG. 3 attached to a ski module.

FIG. 6 front elevation of a personal, tabletop module with a remote console, which may be used with the present invention.

FIG. 7 front elevation of a rehabilitation chair module which may be used with the present invention.

FIG. 8 front elevation of an office desk module which may be used with the present invention.

FIG. 9 front elevation of a module with additional safety features, suitable for geriatric use, which may be used with the present invention.

FIG. 10 is a schematic showing the interchangeability of the elastomeric bushings used in present invention.

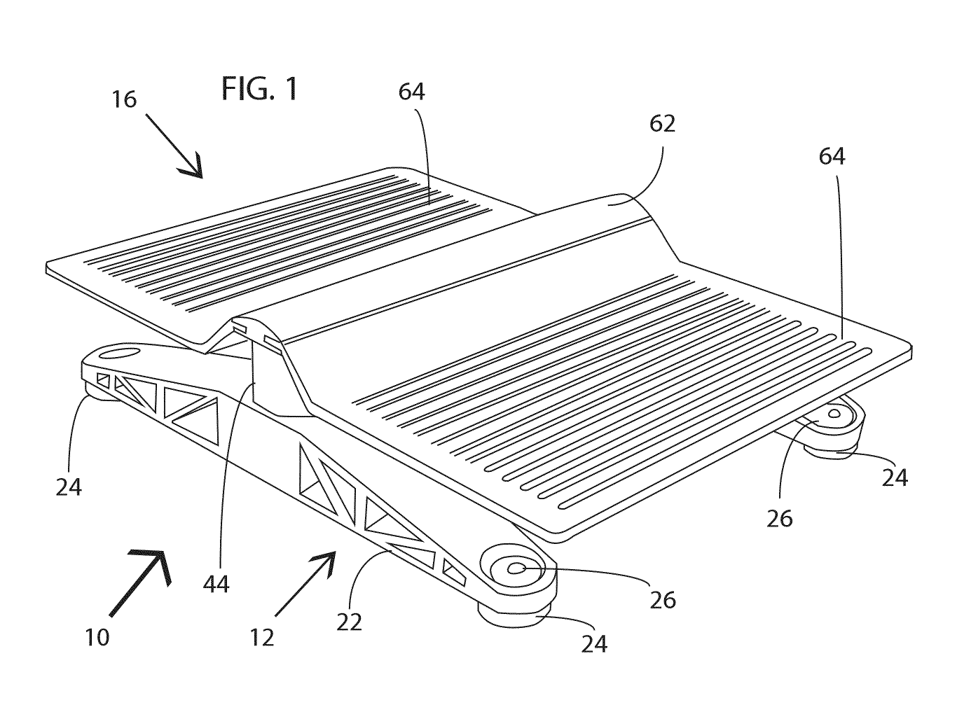

### DETAILED DESCRIPTION OF THE PREFERRED EMBODIMENT

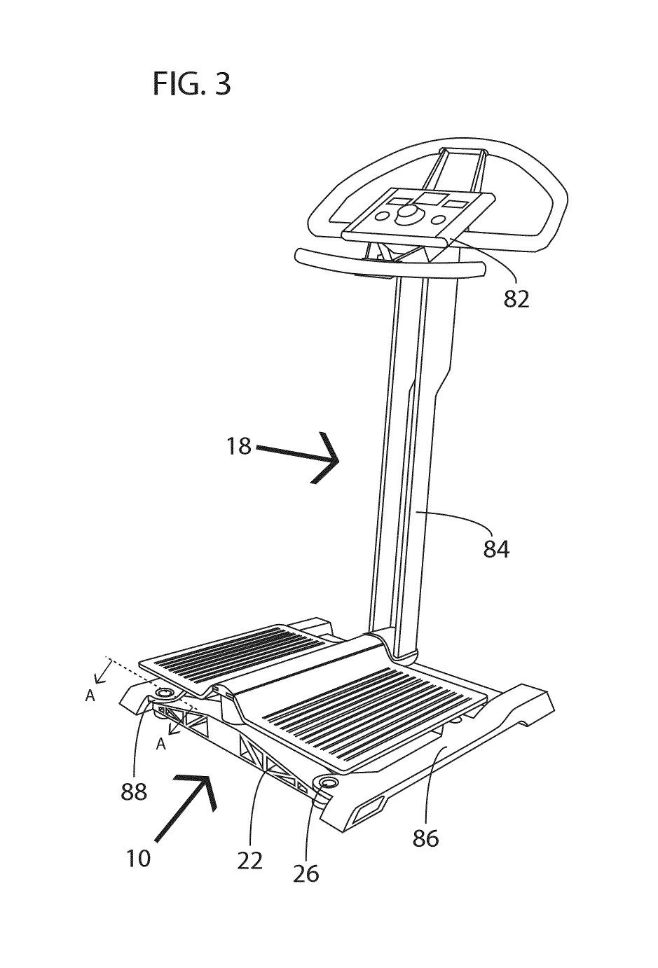

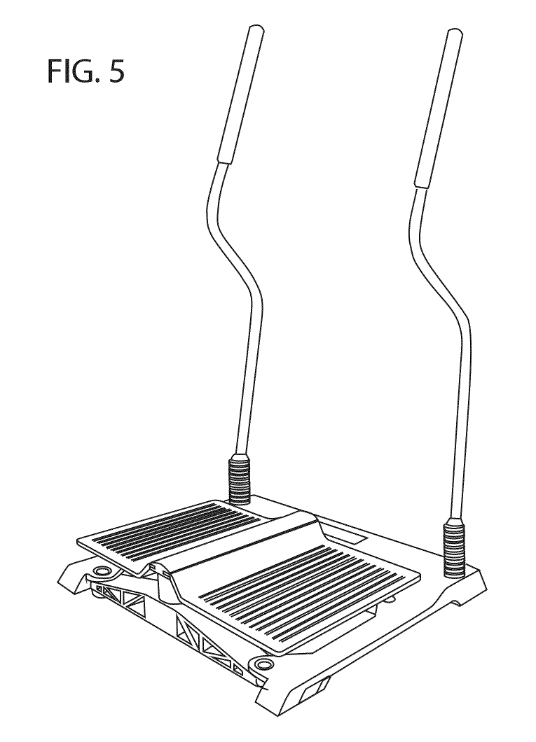

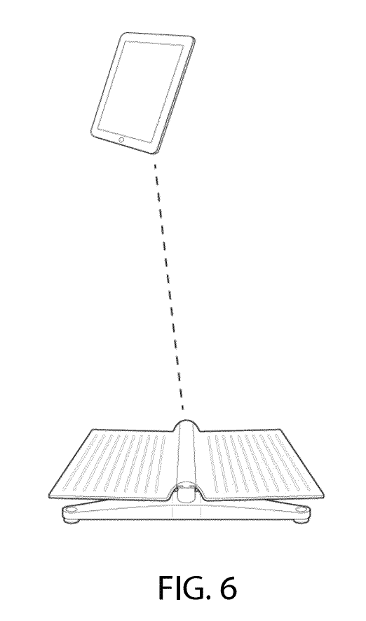

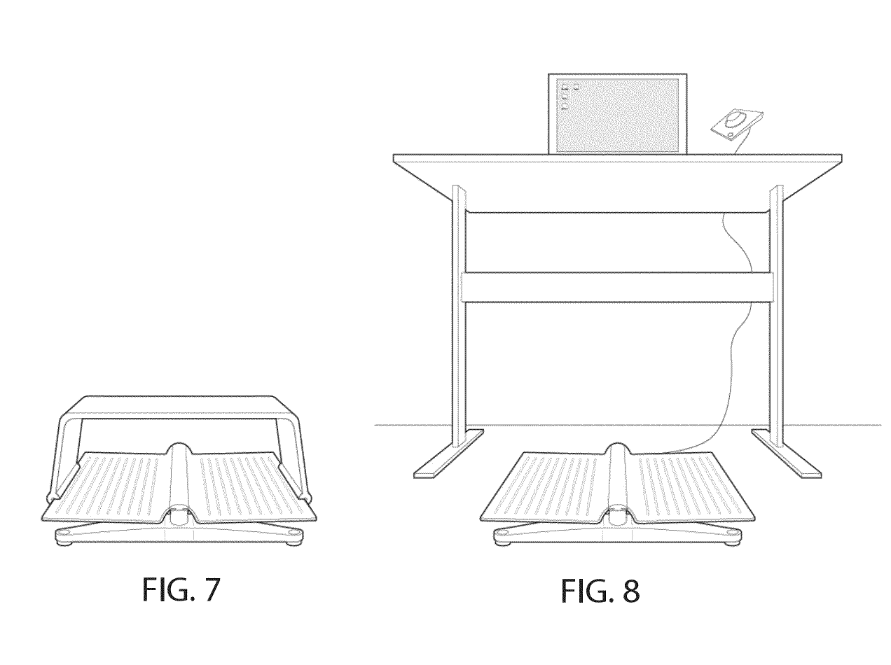

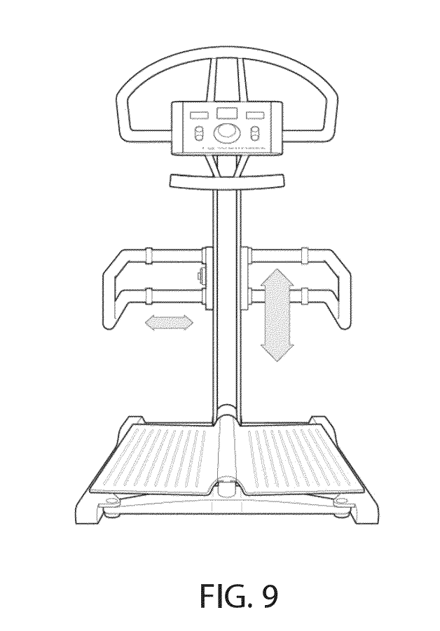

With reference now to the drawings, the preferred embodiment of the platform for a whole body vibrator unit is herein described. It should be noted that the articles “a”, “an”, and “the”, as used in this specification, include plural referents unless the content clearly dictates otherwise. It should also be noted that the specification and drawings are directed to just the platform and drive motor, a console is also required, one example being shown in FIG. 3, for a fully functional unit. Many different types and styles of consoles may be used with the platform, including consoles that regulate multiple platforms. The platform is, in and of itself, modular and may then be used with many differing designs, including sport specific vibrators, office and desk adapted vibrators, chairs, and others, as is shown in FIGS. 5-10.

With reference to the figures, the platform 10 is comprised of three main components, a frame 12, an iso-linear drive system 14 and a carapace 16. The frame 12 holds the drive system 14 and provides a stable base on the ground. It features two legs 22, each with two feet 24 connected by a central beam 28. Generally the frame is made from a strong, durable and light material, such as aluminum. The feet are made of some form of polymer or other elastomeric material and are adjustable by the use of bolts 26.

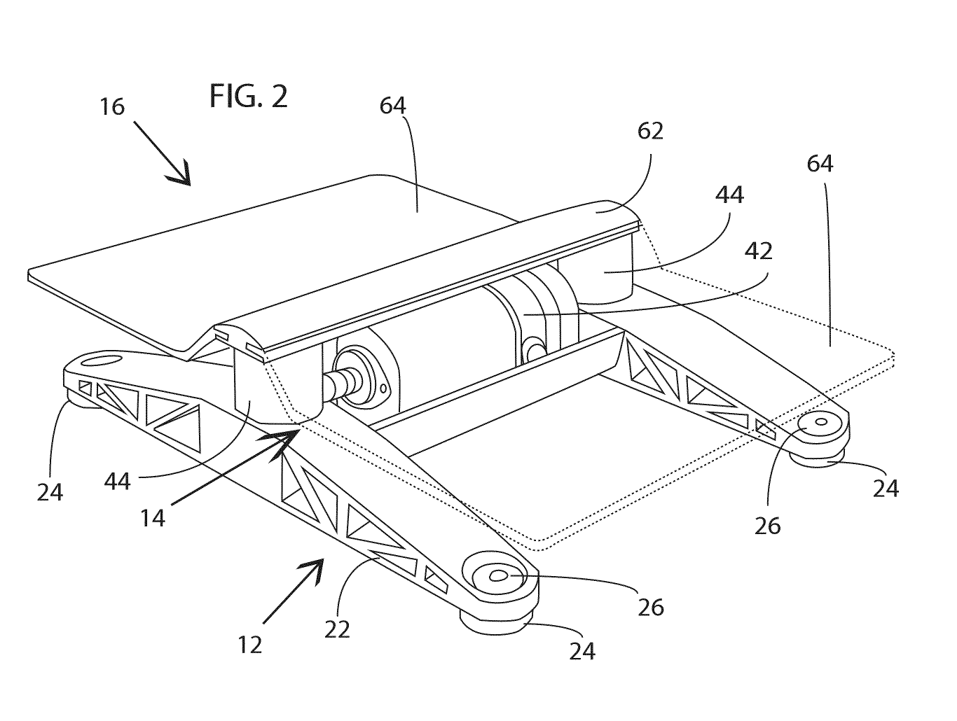

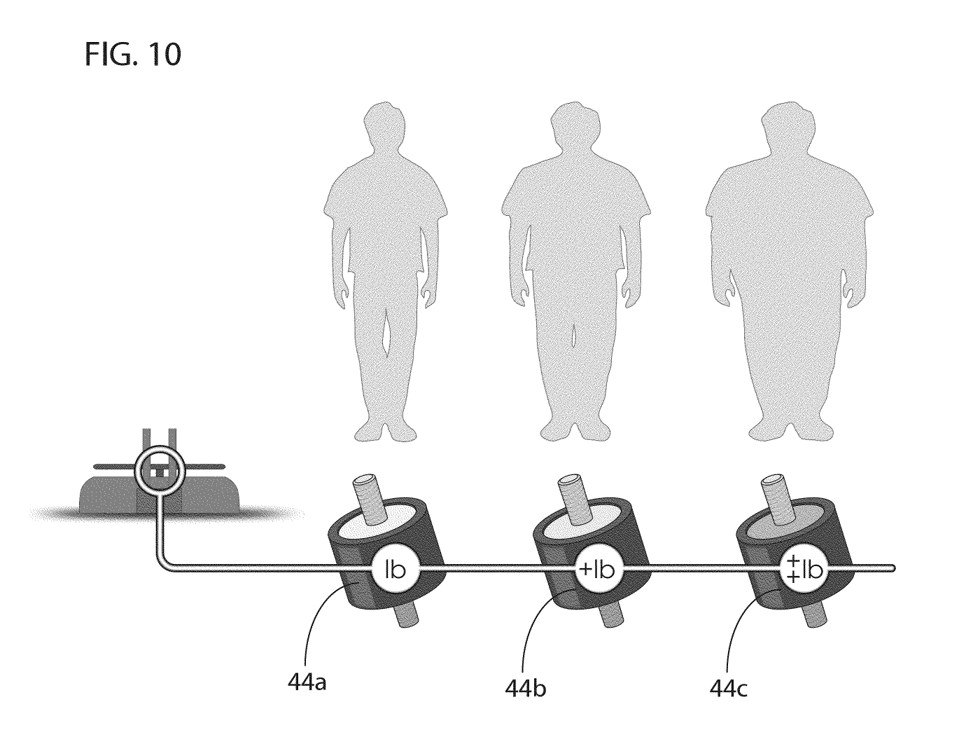

The central beam 28 provides a cradle for the majority of the iso-linear drive system 14, in this case motor 42 and bushings 44. Motor 42 may be of any design necessary to produce oscillatory motion. As such, the motor 42 is represented schematically in FIG. 2. What is important, however, is that the oscillatory motion caused by the motor is imparted upon two elastomeric bushings 44, centrally mounted upon the legs 22, by a yoke (not shown). The use of the bushings 44 is novel in the art and presents a number of advantages. First, the bushings support the majority of the stress caused by a user standing on the platform, as opposed to some portion of the motor. Second, the bushings 44 naturally resist the oscillatory motion to a greater degree as they reach their maximum displacement. This resistance gradually rises as displacement maximizes, causing a natural braking function that cushions the oscillatory motion and makes it less abrupt and jarring. The durometer and resilient qualities of the bushings may be selected by the designer of individual platforms for durability, cushioning, expense or any other factor. As such any elastomeric material (polymers, composites, etc.) may be utilized in the invention. Third, the bushings 44 are also interchangeable (44a, 44b, 44c) and can be selected for desired effect or use, such as for individuals with different weights (FIG. 10). The iso-linear motor design also provide advantages to the platform over the prior art. The yoke and bushing design require only a short stroke from the motor, thereby decreasing needed horsepower from the system. The iso-linear motor also requires fewer parts, so it is naturally quieter than prior art designs. This characteristic is further accentuated by the elastomeric bushings that are used, which provide their own dampening effect. Being linearly mounted in the center of the platform, the torque exerted upon the drive system is less than a conventional system, where the drive is attached to one end of the vibration platform, and is balanced by the user essentially straddling over the iso-linear drive 14.

The carapace 16 is mounted upon the bushings 44 and it is comprised of three major parts: a central strut 62 and two wings 64. The central strut 62 is directly mounted to the bushings and provides a brace for each wing 64. The wings 64 are curved, swooping down from the central strut to a lower height over the remainder of the legs 22. This decrease in height makes the platform easier to mount and dismount by a patient. The drive system 14, however, is housed underneath the central strut 62, where there is a greater height to accommodate the motor 42 and bearings 44. Any suitable material may be used for the central strut 62 and wings 64, including metal, polymers or composites. The carapace may be formed in any shape to maximize benefit.

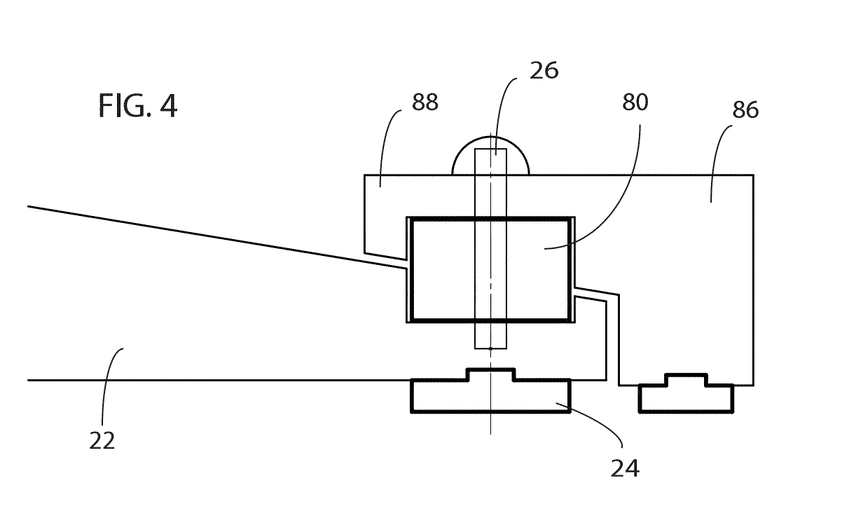

Attachment to a central column is accomplished by connecting the platform to a column structure along the legs 22 of the platform 10 (FIG. 3). Specifically a control column 18 features a control panel 82, a main column 84 and two branches 86 that encompass the sides of the platform 10. Tabs 88 on the branches 86 are connected by the bolts 26 so that the control column 18 is attached to platform 10. An elastomeric isolator 80 (FIG. 4) resides between the legs 22 and each tab 88 so as to prevent vibration from transmitting to the main column 18 from the platform 10. This construction, then, helps improve the performance of the whole system as the main controls for the system as then isolated from vibrations which may disrupt its systems and affect the structural integrity of the whole assembly. Being a modular construction also allows different exercise and control apparatuses, like the ski module of FIG. 5, to be used with the base platform 10.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A vibrator platform comprising:
a. A platform base in which a vibration mechanism is located along a central axis;
b. A carapace, situated over the base and serving as a platform;
c. A plurality of load bushings, located along the central axis between the base and carapace, the load bushings serving as the sole support of the carapace over the platform base.

2. The vibrator platform of claim 1, the load bushings being selectable from a set of load bushings of varying load capacity.

3. The vibrator platform of claim 2, the platform base further comprising a plurality of feet, each one of the plurality of feet being isolated from the platform base by at least one isolator bushing.

4. The vibrator platform of claim 2, the carapace further comprising a central strut, proximate the bushings, and two wings, extending outward from the central strut over the platform base.

5. The vibrator platform of claim 3, the wings of the platform sweeping closer to the platform base than the central strut.

6. The vibrator platform of claim 1, the platform base further comprising a plurality of feet, each one of the plurality of feet being isolated from the platform base by at least one isolator bushing.

7. The vibrator platform of claim 1, the carapace further comprising a central strut, proximate the bushings, and two wings, extending outward from the central strut over the platform base.

8. The vibrator platform of claim 7, the wings of the platform sweeping closer to the platform base than the central strut.

9. The vibrator platform of claim 1, the vibration mechanism being an iso-linear motor, centrally located in the platform base, underneath the carapace and between at least two load bushings.

10. The vibrator platform of claim 9, the load bushings being selectable from a set of load bushings of varying load capacity.

11. The vibrator platform of claim 10, the platform base further comprising a plurality of feet, each one of the plurality of feet being isolated from the platform base by at least one isolator bushing.

12. The vibrator platform of claim 10, the carapace further comprising a central strut, proximate the bushings, and two wings, extending outward from the central strut over the platform base.

13. The vibrator platform of claim 12, the wings of the platform sweeping closer to the platform base than the central strut.

14. The vibrator platform of claim 9, the platform base further comprising a plurality of feet, each one of the plurality of feet being isolated from the platform base by at least one isolator bushing.

15. The vibrator platform of claim 9, the carapace further comprising a central strut, proximate the bushings, and two wings, extending outward from the central strut over the platform base.

16. The vibrator platform of claim 15, the wings of the platform sweeping closer to the platform base than the central strut.
